(19) United States
(12) Patent Application Publication
(10) Pub. No.: US 2011/0115620 A1
(43) Pub. Date: May 19, 2011

(54) System and Method of Preventing Patient Drug Mismatch

(75) Inventor: Gary L. Myers, Monee, IL (US)

(73) Assignee: KMC HOLDING, LLC

(21) Appl. No.: 13/000,834

(22) PCT Filed: Jun. 29, 2009
(86) PCT No.: PCT/US09/03854

§ 371 Date: Dec. 22, 2010

Related U.S. Application Data
(60) Provisional application No. 61/076,417, filed on Jun. 27, 2008.

(51) Int. Cl. G08B 1/08

(52) U.S. Cl. 340/539.12

(57) ABSTRACT

Aspects of the invention disclose a method and system for preventing patient drug mismatch. The method and system may be implemented using RFID technology to match medication to a particular patient. Aspects of the disclosure may be part of a medication administration system and/or a medication dispensing system that may or may not work with a medication and supply management system.

### RELATED APPLICATION DATA

This patent application is related to and claims the benefit of U.S. Provisional Patent Application No. 61/076,417, filed Jun. 27, 2008, which is incorporated by reference in its entirety, without exclusion of any part thereof, and including all incorporated references therein.

### BACKGROUND OF THE INVENTION

This Background section is provided in order to facilitate a better understanding of the Detailed Description herein. It is not the Applicant's intent to survey or summarize the prior art, but rather to provide the reader with background concepts that arise primarily from the Applicant's own internal knowledge, so that the reader has the benefit of these concepts while reading the remainder of the patent document. Thus, nothing in this section should be taken to be, or to imply the existence or features of, any actual item of art or public knowledge, prior or otherwise.

Medication administration is one of the most important responsibilities given to healthcare professionals in caring for patients. A nurse or other healthcare professional must provide the correct medication in the correct dosage to the patient. Any mistake in administering the medication, be it the type of medication or the dosage, could lead to fatal consequences for the patient.

A medical administration system could include a medication and supply management system. This comprehensive system is used to allow a healthcare facility to track costs on a per patient basis, as well as the cost of inventory, in order to identify a need for, or opportunity for, improved and/or more efficient systems or processes. By way of example, one type of medication and supply management system could be a point-of-use system that automates the distribution, management and control of medications and supplies, allowing facilities to operate 24-hours per day. Such a system could, for example, be configured to meet a facility's specific needs, whether it is a long-term care pharmacy, surgery center, small acute or specialty hospital, correctional institution or physician's office. An automated perpetual inventory system could also serve to eliminate manual reordering processes. For example, a minimum level could be set to trigger ordering of the product of interest before a out-of-stock situation occurs.

Other aspects of a medical administration system could include a medication, drug, or other substance dispensing system that delivers the correct material in the correct dosage for the patient. However, current medication or drug dispensing systems can make mistakes possible with regard to administering the correct medication in the correct dosage to the patient. Such mistakes may lead to serious consequences for the patient, i.e., injury or even death. Therefore, there is a need for a system designed to prevent the administration of incorrect medications, or incorrect dosage of correct medications, to the patient.

### BRIEF SUMMARY OF THE INVENTION

The invention pertains to system for providing access to a drug cabinet for purposes of patient treatment. In an embodiment of the invention, the system includes a patient ID bracelet, having therein a patient RFID chip. The patient ID bracelet is adapted to be affixed to a patient so as to indicate the presence of the patient. A patient drug tray is used in an embodiment of the invention as well. The drug tray has a label portion thereon and a tray RFID chip embedded within the label portion. A cabinet is provided for containing the patient drug tray. In an embodiment of the invention, the cabinet has a computing device therein associated with an RFID antenna for detecting and recognizing the patient RFID chip and the tray RFID chip. The cabinet also has a lock to secure its contents, the lock being actuatable by the computing device. The computing device actuates the lock to allow or disallow access to the contents of the cabinet based at least on a comparison between the patient RFID chip and the tray RFID chip.

In another embodiment, a method for providing access to a drug cabinet for purposes of patient treatment is provided. The method includes in general terms scanning an area for RFID signals to determine whether a patient arm band having an RFID chip, a patient prescription RFID chip, and a caretaker tag RFID chip are present within the scanned area. A user attempting access the cabinet may also provide user input at a keypad associated with the cabinet. If a matching arm band RFID chip and patient prescription RFID chip are detected during the step of scanning, and the user input at a keypad associated with the cabinet indicates an authorized access attempt, and the caretaker tag RFID chip is present within the scanned area, then the cabinet automatically allows access.

### BRIEF DESCRIPTION OF THE DRAWINGS

FIG. 1A is a simplified perspective view of an ID bracelet usable in an embodiment of the invention;

FIG. 1B is a simplified schematic of a drug tray according to an embodiment of the invention;

FIG. 1C is a simplified perspective view of a patient cabinet according to an embodiment of the invention;

FIG. 2 is a simplified perspective view of a treatment room having two cabinets associated with respective patient beds according to an embodiment of the invention;

FIG. 3 is a more detailed perspective view of the cabinet 9. As can be seen, the cabinet 9 includes a keypad 30 for pharmacy and nurse access according to an embodiment of the invention;

FIG. 4 is a process flow chart showing a process 40 for granting authorized access or denying unauthorized access to the cabinet 9 contents, i.e., the patient tray(s) 5 according to an embodiment of the invention;

FIG. 5 is a process flow chart showing a process 50 for granting authorized access or denying unauthorized access to the cabinet according to an embodiment of the invention;

FIG. 6 is a process flow chart showing the keypad subroutine 52 in greater detail according to an embodiment of the invention;

FIG. 7 is a data flow chart illustrating a drug routine of FIG. 6 according to an embodiment of the invention;

FIG. 8 is a detailed data diagram showing the authorized user list of FIG. 6 according to an embodiment of the invention;

FIG. 9 is a schematic view of a system according to an embodiment of the invention;

FIG. 10 is a table showing preprogrammed responses to be displayed on the LCD display as appropriate according to an embodiment of the invention; and

FIG. 11 is a flow chart showing a hierarchy of menus. and submenus usable for a user interface via the LCD display device within an embodiment of the invention.

### DESCRIPTION OF THE INVENTION

The description of the invention includes the figures that are part of this disclosure and are referenced herein. In overview, aspects of the invention include a method and system for preventing patient drug mismatch, i.e., associating an incorrect medication or dosage with a particular patient. In one aspect, the disclosure pertains to a medication administration system and/or a medication dispensing system that may work in conjunction with a medication and supply management system.

In an exemplary system according to the disclosed principles, a radio frequency identification (RFID) tag is installed into a patient identification bracelet, for a patient being cared for or treated at a healthcare facility. A separate RFID tag is installed in a label of a drug dispensing traveling bin, wherein the bin contains medication for the patient. A drug cabinet installed in the patient's room in the healthcare facility comprises an antenna for receiving information from the RFID tag on the patient's identification bracelet. In a further aspect, an input device such as a keypad or RFID tag reader may also be installed in or associated with the drug cabinet.

Continuing with the same example, a liquid crystal display (LCD) unit is also preferably installed in or otherwise associated with the drug cabinet. In addition, a central processing unit (CPU) installed in the drug cabinet compares the RFID tag information it receives from the patient's identification bracelet, through the antenna, with the RFID tag information it receives from the RFID tag in the traveling bin through the input device. To execute a control and regulation function, the CPU is also configured and connected so as to control a lock restricting access to the drug cabinet.

The invention also includes, in one aspect, a method of providing a system such as that described above as well as a process of operation of such a system. An exemplary method of such provision may comprise the following steps. At a first step, an RFID tag is attached to an identification (ID) bracelet typically placed on a patient in a healthcare facility. At a next step, which may occur before, after or in parallel with the first step, an antenna and LCD unit are installed in the patient's room. The antenna and LCD unit may be attached to the drug dispensing cabinet as shown in the Figures. At another step, which again may occur independently of the timing of the other steps, a CPU is installed into the drug cabinet. An input device, such as a keypad or RFID tag reader, is installed into the drug cabinet as a fourth step.

Continuing with describing the exemplary method, a physician or other healthcare professional enters a drug prescription order into a medication and supply management system for the patient. A pharmacy associated with the healthcare facility receives the drug prescription order and pharmacy personnel review the drug prescription and place the correct medications into a current traveling bin. The current traveling bin contains a label displaying the patient's name. In one aspect of the invention, the label is installed with an RFID tag matching the RFID tag in the patient's identification bracelet. At another step, facility personnel transport the current traveling bin containing the medication to the patient's room in the healthcare facility.

At this stage of the process, the healthcare professional attempts to load the traveling bin into the drug cabinet. This may be done by entering a pharmacy code into the input device. The LCD unit displays the patient name transmitted by the CPU when it received the pharmacy code from the input device and unlocks the cabinet.

Alternatively, in another step, if the patient is in the room and if the patient is within a specific distance of the drug cabinet, then the drug cabinet can be unlocked and opened. This can be done by the following exemplary steps. At another step, a CPU scans the room using the antenna to detect the patient within the room. The CPU receives the patient's name from the RFID tag in the patient's bracelet. At another step, a healthcare professional enters the RFID tag information in the label of the current traveling bin into the input device installed in the drug cabinet. The CPU installed in the drug cabinet matches the RFID tag from the current traveling bin with the RFID tag it receives through the antenna from the patient's bracelet. Only after the CPU matches the two RFID tags does the CPU unlock the drug cabinet. At another step, the LCD displays the patient's name within the room. At another step, if the CPU does not find a match between the two RFID tags, then the CPU does not unlock the drug cabinet.

The drug cabinet unlocking with or without a proper mismatch has an option of auditing the access attempt. The access can be through a keypad or a wireless input device or the like. However, access is not granted through an unsecured simple key, keypad or input device.

Aspects of the invention can be integrated into other patient care methods and systems (e.g., equipment tracking, etc.) associated with a healthcare facility. Aspects of the invention are designed to stand alone without requiring any significant computer or system integration.

Aspects of the invention may use passive sensor (or voluntary usage) RFID technology rather than active sensor RFID technology. Active sensors may be disabled with simple techniques such as covering the sensors with aluminum foil. Most active sensors are used to prevent shoplifting at retail stores. However, passive RFID technology may provide better performance for certain aspects of the invention than active sensor RFID technology, (but not all aspects) because passive sensors are better suited to provide access to storage devices (e.g., drug cabinets).

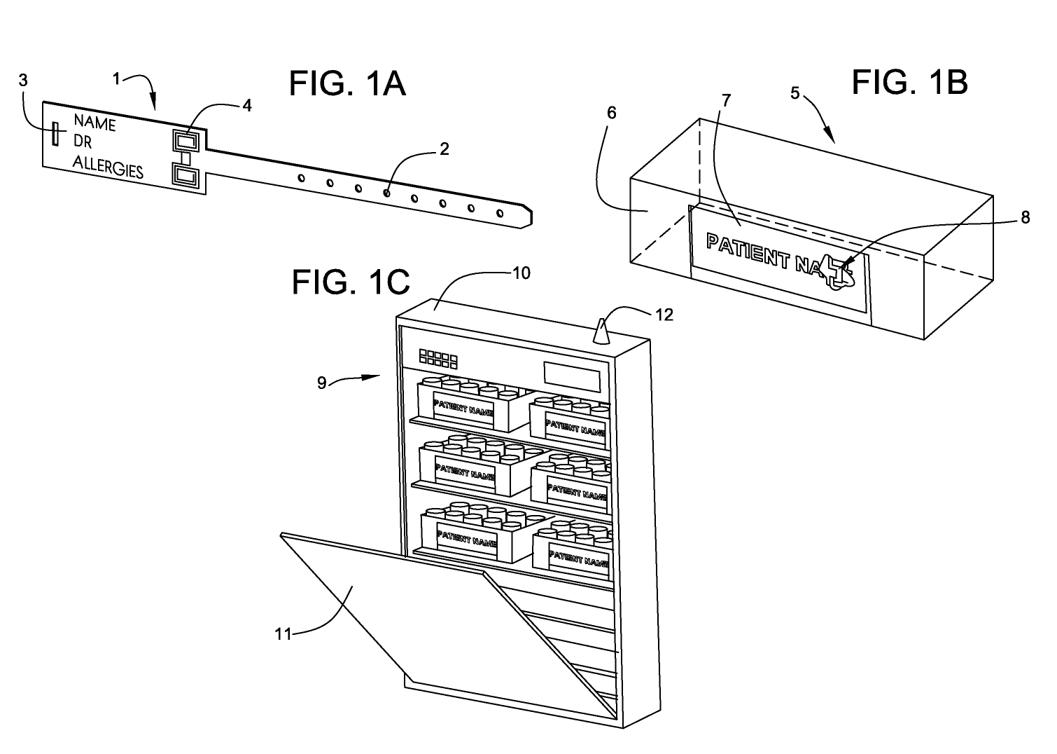

Having given the above overview, certain aspects of the invention will be discussed in greater detail below with respect to FIGS. 1-11. While reading this disclosure, the reader is reminded that although aspects of the invention are shown to be implemented in the healthcare industry, aspects of the invention may used in other applications and contexts where less costly, stand alone access lock-out is beneficial.

FIG. 1A is a simplified perspective view of an ID bracelet usable in an embodiment of the invention. The bracelet 1 includes a strap portion 2 for being affixed to a patient's wrist, as well as an ID portion 3. The ID portion 3 lists information of relevance to the patient or caregiver, such as patient name, doctor name, and any allergies. An RFID chip 4 is embedded in the ID portion 3, in such a way that it may be, but need not be, hidden from the patient.

FIG. 1B is a simplified schematic of a drug tray 5. In the illustrated embodiment of the invention, the drug tray 5 includes a body portion 6. A patient label portion 7 affixed to the body portion 6 records necessary information such as patient name, etc. An RFID chip 8 is embedded in the patient label portion 7

FIG. 1C is a simplified perspective view of a patient cabinet 9. The patient cabinet 9 includes a body portion 10 as well as a door 11. Patient medications and drugs are stored in the cabinet 9, as will be discussed in greater detail later, and the door 11 secures the contents of the cabinet 9 when closed. An RF antenna 12 or other suitable RF sensor is located on the cabinet 9 for detecting and reading RFID chips.

In practice, by way of example, the system shown in FIGS. 1A-C is used to securely associate patient medications with the intended patient. Thus, hospital admission staff will create a patient record and will create the bracelet 1 and fasten it to the patient. The pharmacy fills the drug/medication orders for the patient and matches the drug tray 5 to the patient. The drug tray 5 is then sent to the patient's room, wherein the cabinet 9 resides. The drug tray 5 is then locked into the cabinet 9 for later authorized retrieval.

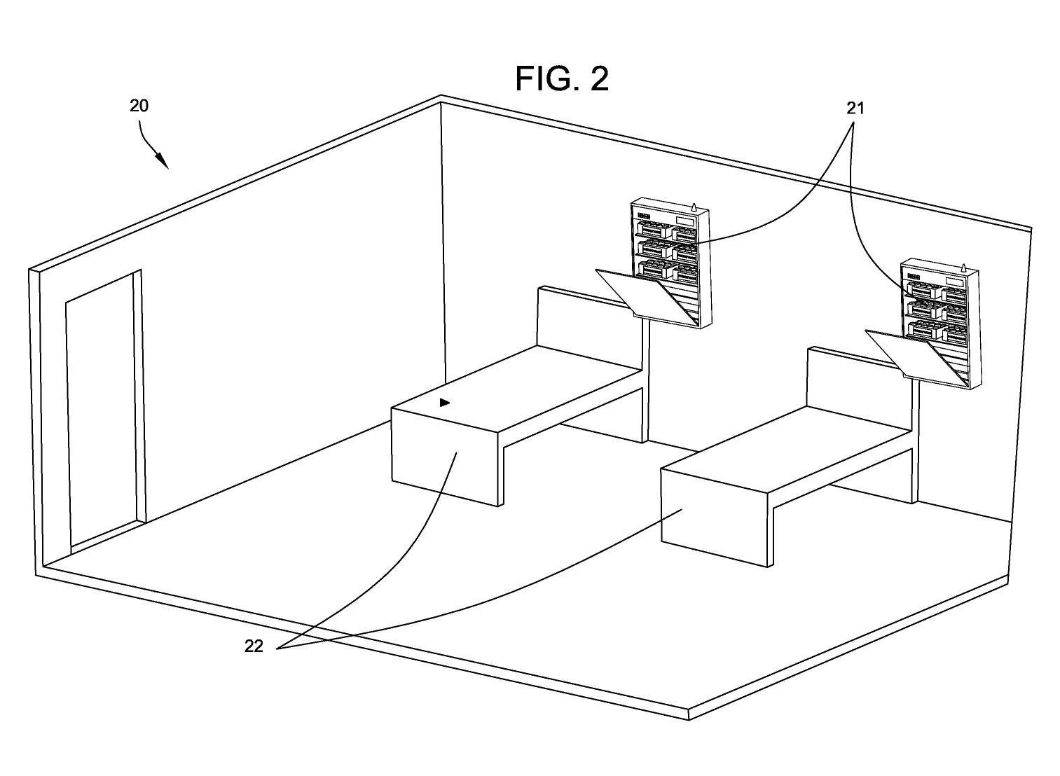

FIG. 2 shows a simplified perspective view of a treatment room 20 having two cabinets 21 associated with respective patient beds 22. The cabinets are of the design discussed with respect to FIG. 1C. In an embodiment of the invention, each cabinet cannot be opened unless the proper associated patient is near enough to be detected (vie bracelet 1) and verified by the RFID sensor associated with the relevant cabinet.

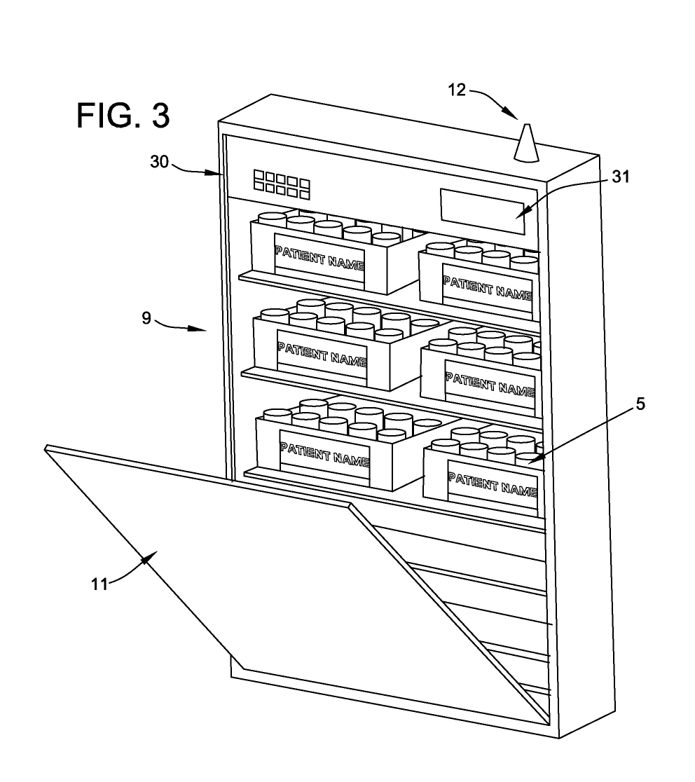

FIG. 3 is a more detailed perspective view of the cabinet 9. As can be seen, the cabinet 9 includes a keypad 30 for pharmacy and nurse access. The cabinet 9 in the illustrated embodiment of the invention also includes an LCD screen 31 for displaying lock status, authorization, and patient information. The patient trays 5 within the cabinet 9 and the RFID antenna 12 can also be clearly seen in the drawing. In an embodiment of the invention, the door 11 is self-closing, e.g., via spring or hydraulic closer, and self-locking, to avoid the risk of accidentally leaving the door ajar and/or unlocked.

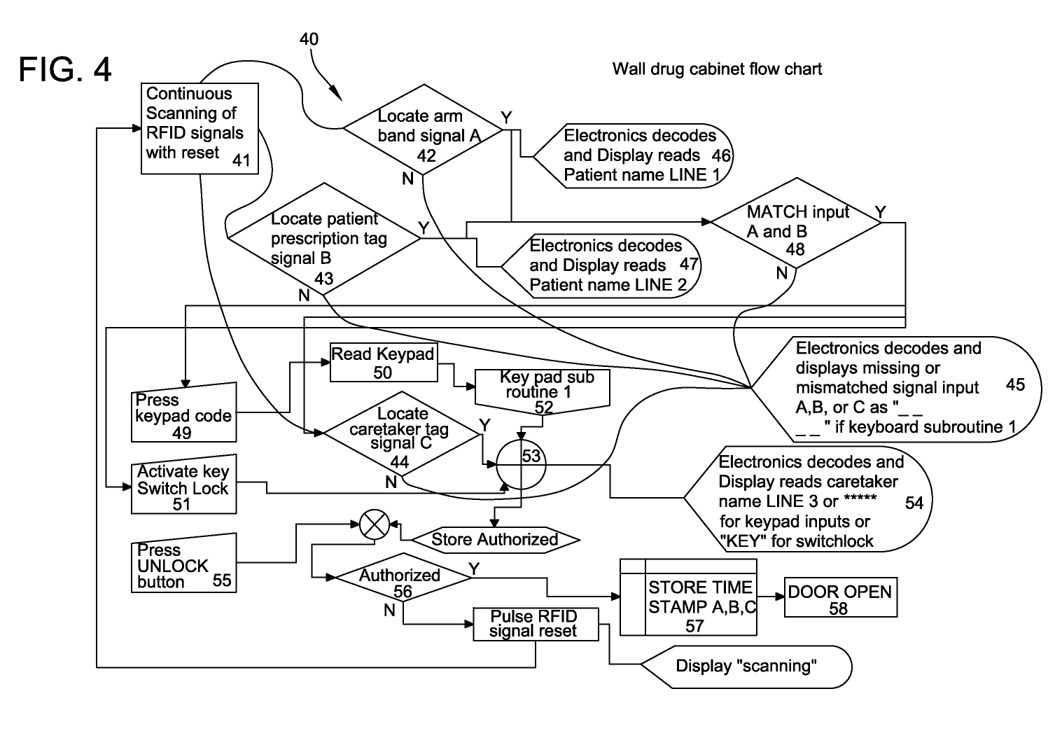

FIG. 4 is a process flow chart showing a process 40 for granting authorized access or denying unauthorized access to the cabinet 9 contents, i.e., the patient tray(s) 5. At a stage 41, the CPU scans for RFID signals via the antenna 12. The scanning may result in the locating of an arm band (bracelet) RFID signal 42, a patient prescription tag RFID signal 43, or a carrier tag RFID signal 44. If no such signal is detected, the CPU causes an appropriate display to be shown indicating that no signal was found or that no matched signal was found. If the CPU detects the arm band RFID signal 42 and patient prescription tag RFID signal 43, then at stage 46/47, the display is made to display the associated patient name/prescription name. At stage 48, the CPU attempts to match the arm band RFID signal 42 and patient prescription tag RFID signal 43. If there is no match, then stage 45 is again executed. If a match is found at stage 48, then the CPU (1) receives a keypad code at stage 50 that was entered by a user at stage 49 and (2) activates a key switch lock at stage 51 in parallel. Subsequent to stage 50, the CPU executes a keypad subroutine at stage 51.

The results of stages 52, 44, and 51 are evaluated at stage 53. If all of the three signals are positive (i.e., if the keypad entry is correct, the caretaker signal is present, and the key switch lock is opened), then the CPU causes an appropriate display to be presented in stage 54. In addition, if the unlock button of the keypad is pressed, then the CPU determines at stage 56 that access to the contents of the cabinet 9 is authorized, stores a time stamp for auditing purposes in stage 57, and activates the cabinet 9 lock to open at stage 58.

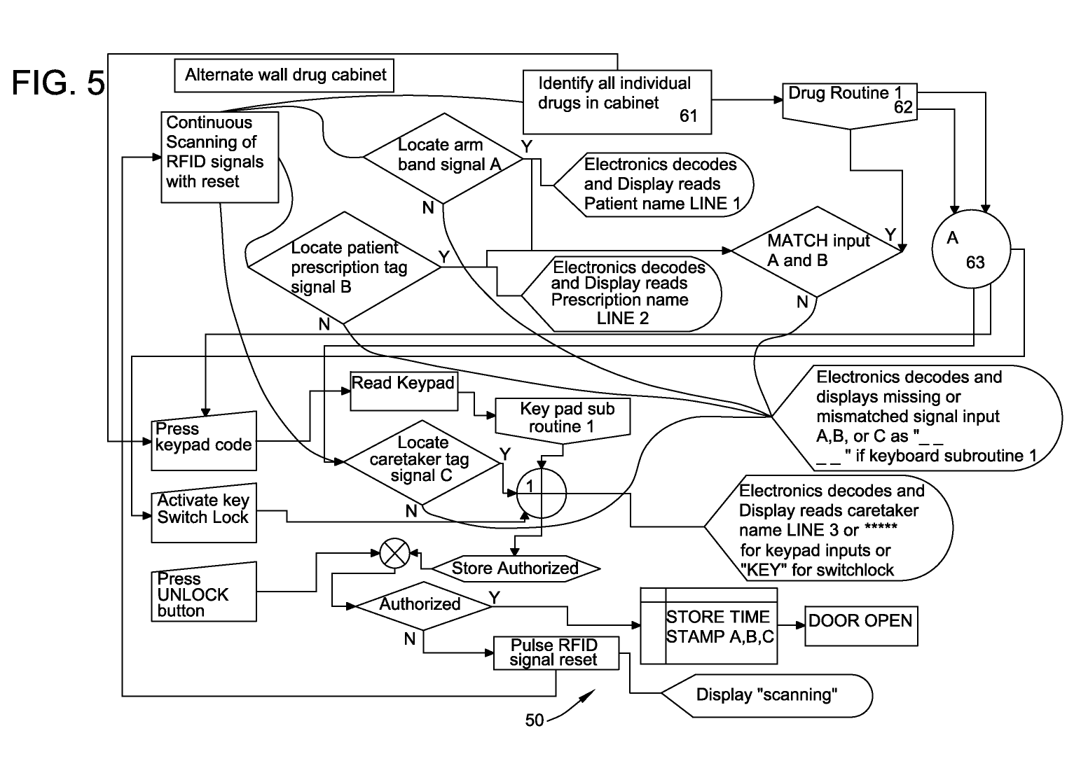

FIG. 5 is a process flow chart showing a process 50 for granting authorized access or denying unauthorized access to the cabinet 9 contents similar to the process 40 of FIG. 4. However, the process includes an additional optional branch for verifying that access to individual drugs in the cabinet 9 is appropriate. In particular, at stage 61, the CPU identifies all drugs in the cabinet 9 via RFID signals from tags on or associated with the drug containers. A drug routine 62 passes an identifier for each drug on for comparison at stage 63 to ensure that there is a match between each drug and the patient. From stage 63, the process 60 proceeds in the same manner as process 40.

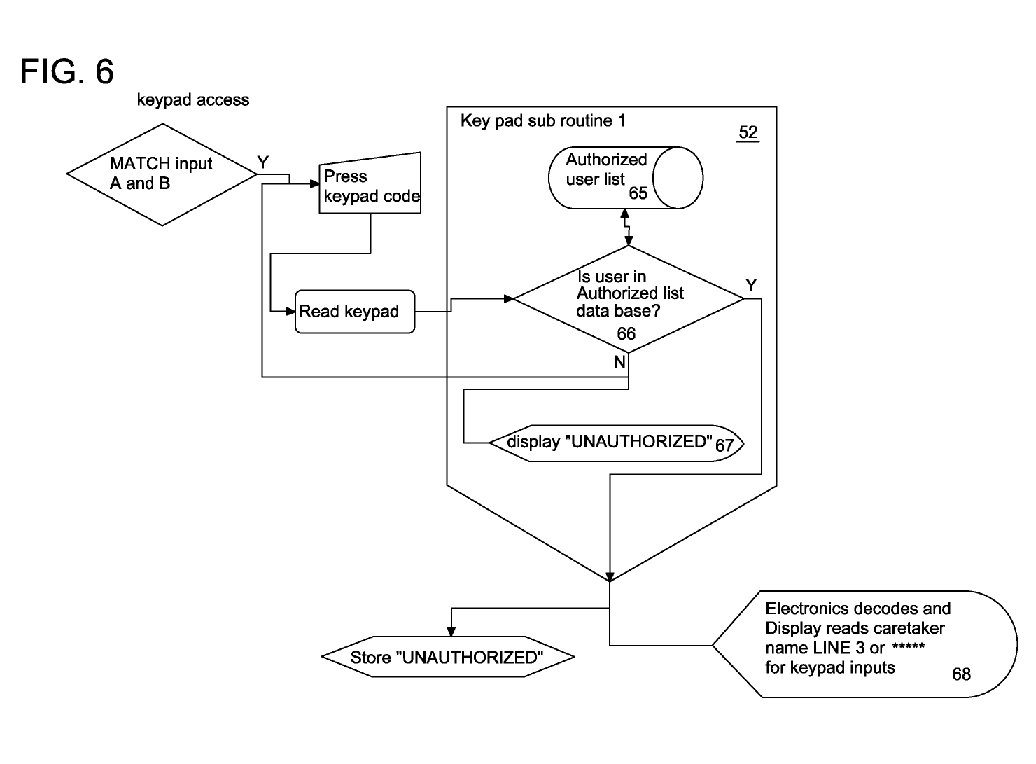

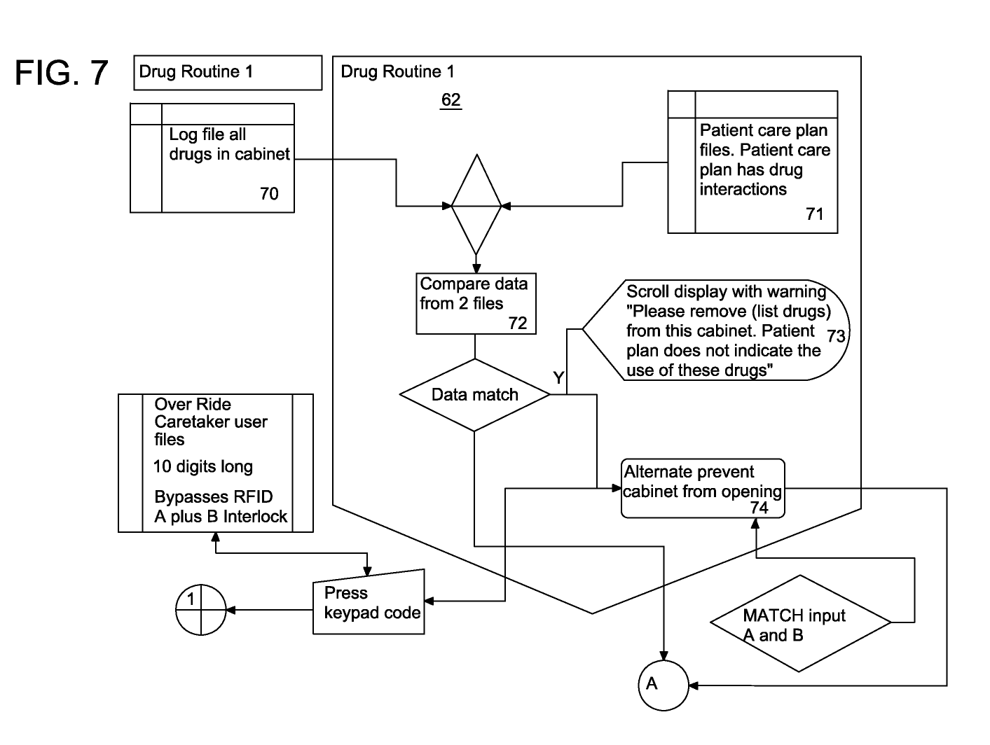

Drug routine 62 of FIG. 6 is explained in further detail with reference to FIG. 7. In particular, at stage 72 of drug routine 62 a log file 70 of all drugs in the cabinet is compared to a patient care plan file 71. In this embodiment of the invention, the patient care plan file 71 includes drug interaction information identifying drugs that are not authorized or recommended for the patient. If the two operands are consistent, or “match,” then the process proceeds to stage 73, and causes a warning to be displayed via the LCD unit, such as “Please remove [list drugs] from this cabinet. Patient plan does not indicate the use of these drugs.” Alternatively, the routine 62 may simply prevent the cabinet from opening at stage 74.

If a match is not found at stage 72, then the opening of the cabinet proceeds as discussed above, dependent upon the various RFID signals to ensure appropriate access. In an embodiment of the invention, a user may override the lock using the keypad if the user possesses an appropriate code.

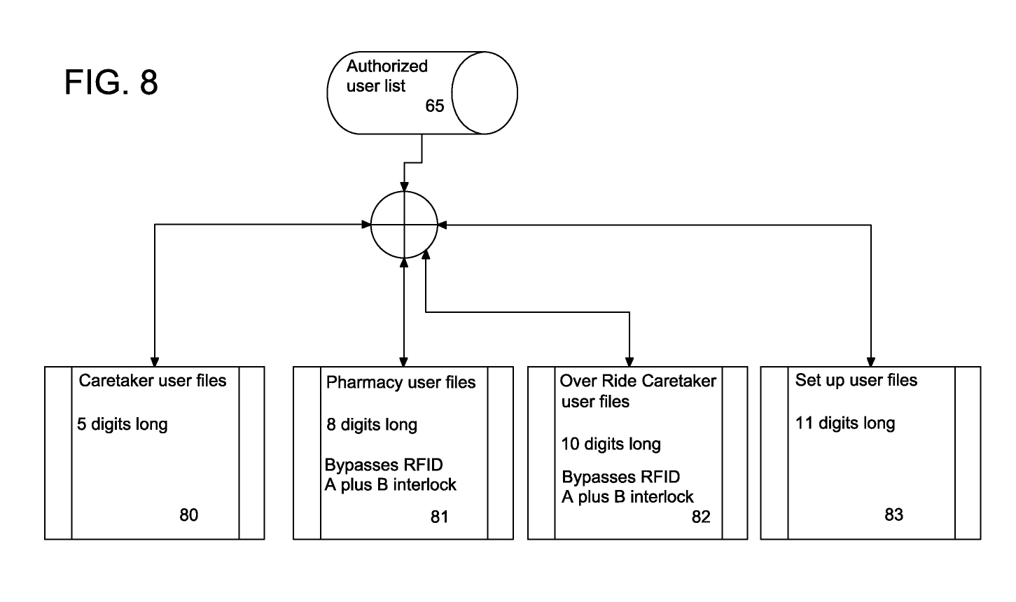

FIG. 6 is a process flow chart showing the keypad subroutine 52 in greater detail. In particular, after entry of the keypad code as per FIG. 4 or 5, the routine 52 identifies the user and uses an Authorized User List 65 in stage 66 to determine if the user attempting access is an authorized user. The authorized user list 65 of FIG. 6 is explained in further detail in FIG. 8. The authorized user list 65 is derived from caretaker user files 80, pharmacy user files 81, override caretaker user files 82, and setup user files 83. If the user is not an authorized user, the routine 52 causes a message such as “unauthorized” to be displayed at stage 67 and exits to await further input. Otherwise, the routine 52 proceeds to stage 68, causing an appropriate message such as the caretaker name or entered code. The routine 52 may also store data related to the access for tracking or other purposes.

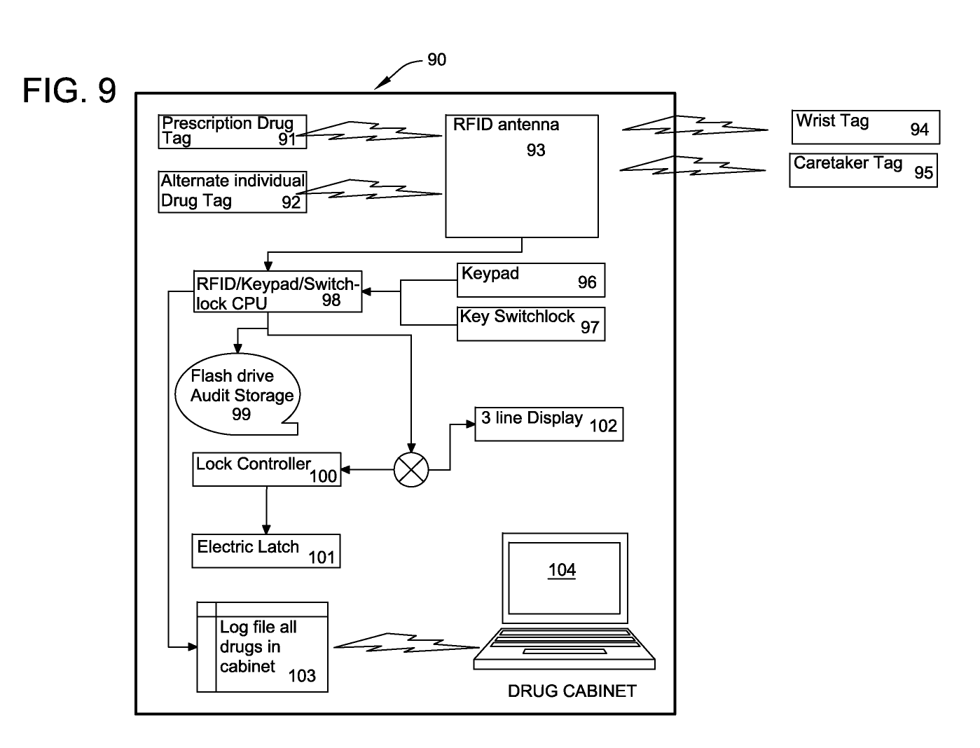

FIG. 9 is a schematic view of a system 90 according to an embodiment of the invention. The system 90 includes the prescription drug tag 91, the alternate individual drug tag 92, the RFID antenna 93, as well as the patient wrist tag 94 and caretaker tag 95. The system 90 also includes a keypad 96 and a key switch lock 97. The RFID antenna 93 detects and reads the prescription drug tag 91, the alternate individual drug tag 92, the patient wrist tag 94 and the caretaker tag 95, when present, and passes the results to the CPU functions 98 that determine access. These functions 98 also receive data from the keypad 96 and the key switchlock 97.

The results of these functions 98, i.e., the identity of the individual attempting access, the patient ID, whether access is to be granted etc., are passed on to other elements for both tracking and operational purposes. For example, all or some of the results may be logged for auditing, e.g., in flash storage 99, while appropriate portions of the results are also used to control the door latch 101 via the lock controller 100. The LCD display 102 is also updated via the results of functions 98. Where the alternate individual drug tags 92 are present, data regarding these tags is included in the results 98 for logging in an appropriate log file 103.

In an advanced alternate embodiment, a computer 104, either built-in or stand-alone, is used to chart the patient care plan. In the case of a stand-alone computer, the computer 104 may be connected to the system 90 via a hardwire network connection or a wireless network connection such as over Bluetooth or 802 wireless. Using the computer 104, the interfaced files are compared to the RFID tags in the drug cabinet. If this comparison shows that a drug located in the cabinet is not allowed to be dispensed to the patient for reasons of allergy, interaction, etc., then a lock-out routine may be initialized as previously discussed.

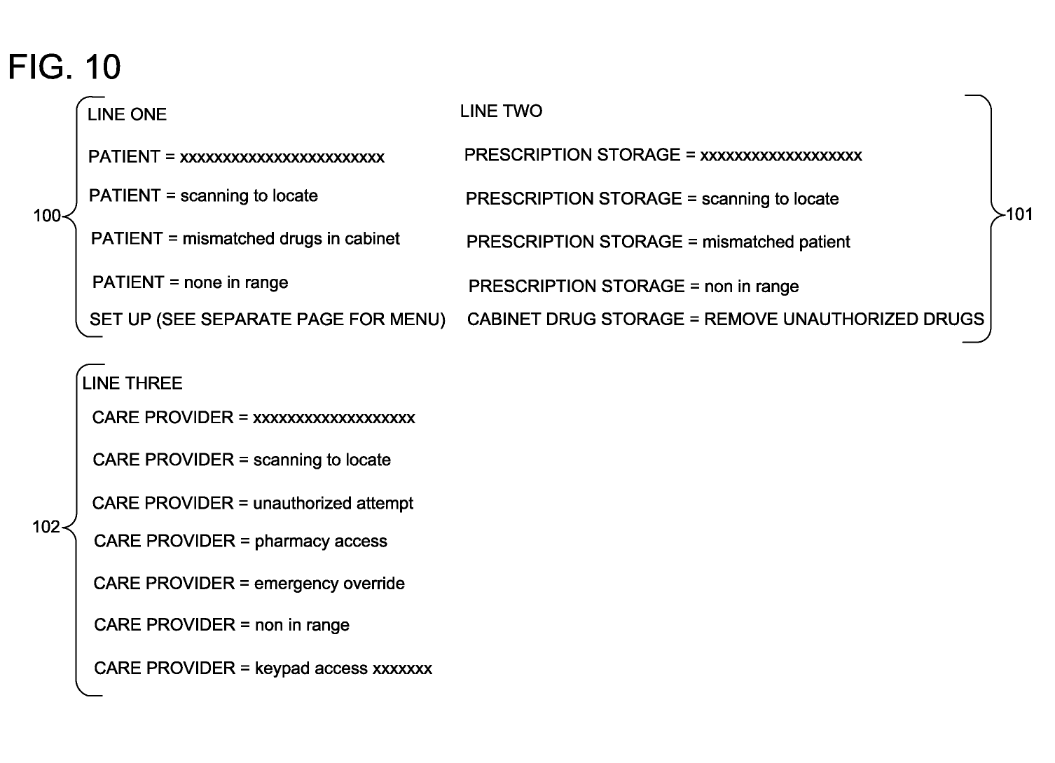

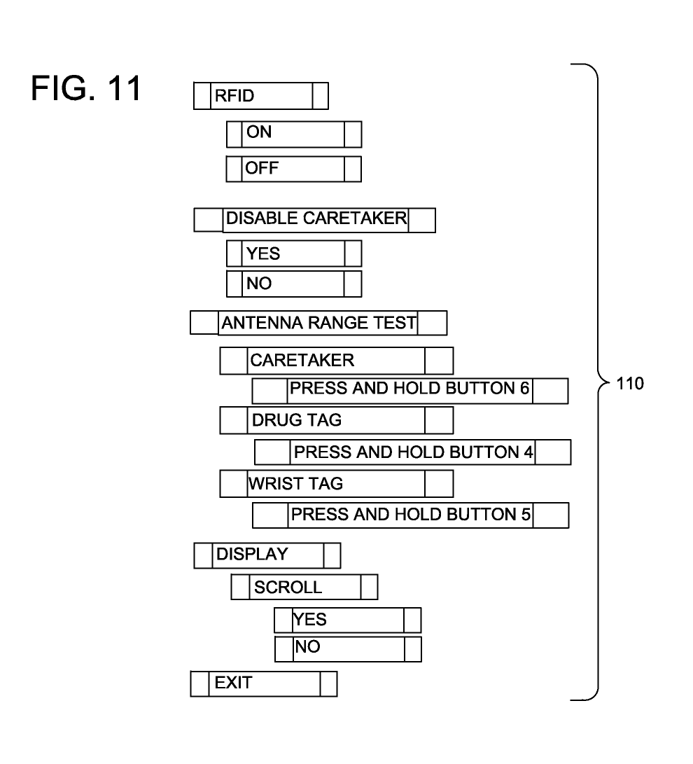

FIG. 10 is a table showing preprogrammed responses to be displayed on the LCD display as appropriate. The preprogrammed responses include option 100 for line one, options 101 for line 2, and options 102 for line 3, in a 3-line display system. FIG. 11 is a flow chart showing a hierarchy of menus and submenus usable for a user interface via the LCD display device.

Although the illustrated examples utilize RFID technology, it will be appreciated that the principles of the invention described herein may be similarly applied through the use of bar code technology. For example, in an embodiment of the invention, an optical bar code may be used to identify patient, drugs, drug tray, caregiver, and so on. In another embodiment of the invention, a magnetically readable bar code or other magnetically readable code is used in lieu of RFID technology to identify the noted persons and items.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

I claim:

1. A system for providing access to a drug cabinet for purposes of patient treatment, the system comprising:
a patient ID bracelet, wherein the patient ID bracelet includes therein a patient RFID chip, the patient ID bracelet being adapted to be affixed to a patient;
a patient drug tray having a label portion thereon and a tray RFID chip embedded within the label portion; and
a cabinet for containing the patient drug tray, the cabinet having a computing device therein associated with an RFID antenna for detecting and recognizing the patient RFID chip and the tray RFID chip, the cabinet further having a lock to secure its contents, the lock being actuatable by the computing device, whereby the computing device actuates the lock to allow or disallow access to the contents of the cabinet based at least on a comparison between the patient RFID chip and the tray RFID chip.

2. The system for providing access to a drug cabinet for purposes of patient treatment according to claim 1, wherein the cabinet further comprises a display panel and a keypad for user interaction, and wherein the display panel and keypad for user interaction are externally accessible while the cabinet is locked.

3. The system for providing access to a drug cabinet for purposes of patient treatment according to claim 2, wherein the computing device is adapted to continually scan for detectable RFID chips via the RFID antenna.

4. The system for providing access to a drug cabinet for purposes of patient treatment according to claim 2, wherein the computing device causes a patient name to be displayed if the patient RFID chip is detected.

5. The system for providing access to a drug cabinet for purposes of patient treatment according to claim 2, further comprising a drug RFID chip associated with at least one drug within the patient drug tray, when the patient drug tray is within the cabinet.

6. The system for providing access to a drug cabinet for purposes of patient treatment according to claim 5, wherein the computing device causes a drug name to be displayed when the drug RFID chip is detected.

7. The system for providing access to a drug cabinet for purposes of patient treatment according to claim 2, further comprising a caretaker RFID chip wearably associated with a caretaker assigned to the patient.

8. The system for providing access to a drug cabinet for purposes of patient treatment according to claim 7, wherein the computing device causes a caretaker name to be displayed when a caretaker RFID chip associated with the caretaker is detected.

9. The system for providing access to a drug cabinet for purposes of patient treatment according to claim 2, wherein the computing device actuates the lock to allow or disallow access to the contents of the cabinet based also on receipt of an entry code via the keypad.

10. The system for providing access to a drug cabinet for purposes of patient treatment according to claim 2, wherein the computing device is further adapted to log accesses and access attempts to the cabinet contents.

11. A method for providing access to a drug cabinet for purposes of patient treatment, the method comprising:
scanning an area for RFID signals to determine whether any of a patient arm band having an RFID chip, a patient prescription RFID chip, and a caretaker tag RFID chip are present within the scanned area;
receiving a user input at a keypad associated with the cabinet;
if an arm band RFID chip and patient prescription RFID chip are detected during the step of scanning, comparing the arm band RFID and patient prescription RFID;
if the arm band RFID and patient prescription RFID match, then determining whether the user input at a keypad associated with the cabinet indicates an authorized access attempt and determining whether the caretaker tag RFID chip is present within the scanned area; and
allowing access to the cabinet if the keypad entry is correct and the caretaker tag RFID chip is present.

12. The method for providing access to a drug cabinet for purposes of patient treatment according to claim 11, wherein determining whether the user input at a keypad associated with the cabinet indicates an authorized access attempt comprises executing a keypad subroutine.

13. The method for providing access to a drug cabinet for purposes of patient treatment according to claim 11, wherein allowing access to the cabinet if the keypad entry is correct and the caretaker tag RFID chip is present comprises also determining that a key switch lock is opened.

14. The method for providing access to a drug cabinet for purposes of patient treatment according to claim 11, wherein allowing access to the cabinet if the keypad entry is correct and the caretaker tag RFID chip is present further comprises displaying an indication of access authorization on a display device associated with the cabinet.

15. The method for providing access to a drug cabinet for purposes of patient treatment according to claim 11, wherein allowing access to the cabinet if the keypad entry is correct and the caretaker tag RFID chip is present further comprises storing a time stamp associated with the access attempt.

16. The method for providing access to a drug cabinet for purposes of patient treatment according to claim 11, further comprising identifying all drugs in the cabinet via RFID signals from tags on or associated with the drug containers, and verifying that access to individual drugs in the cabinet is authorized.

17. The method for providing access to a drug cabinet for purposes of patient treatment according to claim 16, wherein verifying that access to individual drugs in the cabinet is authorized comprises evaluating an identifier for each drug to determine whether there is a match between each drug and the patient.

18. The method for providing access to a drug cabinet for purposes of patient treatment according to claim 11, wherein determining whether the user input at the keypad associated with the cabinet indicates an authorized access attempt further comprises:
associating the user input with a particular user;
comparing the particular user with a list of authorized users; and
determining that the user input indicates an authorized access attempt if the particular user is named on the list of authorized users.
